(19) United States
(12) Patent Application Publication
(10) Pub. No.: US 2005/0219448 A1
(43) Pub. Date: Oct. 6, 2005

(54) Liquid crystal structure for retardation compensation of STN LCD

(75) Inventors: Pao-Chang Chen, Ping Chen City (TW); Jve-Jong Chen, Ping Chen City (TW); Bor-Ping Wang, Ping Chen City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Optimax Technology Corporation

(21) Appl. No.: 11/059,043

(22) Filed: Feb. 16, 2005

(30) Foreign Application Priority Data
Apr. 1, 2004 (TW) 93109140

(51) Int. Cl. G02F 1/1335

(52) U.S. Cl. 349/119

(57) ABSTRACT

A liquid crystal structure for compensating for the retardation of STN LCD is described. The liquid crystal structure has at least a first polarizer, a first liquid crystal compensation film, a main liquid crystal layer, a second liquid crystal compensation film, and a second polarizer. A main retardation is introduced when the light passes through the main liquid crystal layer. When the light passes through the first liquid crystal compensation film and the second liquid crystal compensation film, a first compensation retardation and a second compensation retardation are obtained, respectively, to compensate for the main retardation, so that a biaxial compensation is achieved. The material of the first liquid crystal compensation film and the second liquid crystal compensation film is nematic liquid crystal.

### RELATED APPLICATIONS

The present application is based on, and claims priority from, Taiwan Application Serial Number 93109140, filed on Apr. 1, 2004, the disclosure of which is hereby incorporated by reference herein in its entirety.

### BACKGROUND

1. Field of Invention

The present invention relates to a liquid crystal structure. More particularly, the present invention relates to a liquid crystal structure using compensation films made of liquid crystal material.

2. Description of Related Art

In the field of displays, LCDs are developing rapidly because of their power saving ability and small volume features. STN (super twisted nematic) liquid crystal display is a common type of LCD. A typical LCD includes a back light module, a rear polarizer, a liquid crystal layer, and a front polarizer. When a light is generated from the back light module and passes through the rear polarizer, the light becomes a linearly polarized light. Because of the birefringence characteristic of liquid crystal molecules, light becomes elliptically polarized after passing through the liquid crystal layer. A retardation is also produced. Because of the retardation, different gray scales may appear when viewing the LCD in different directions. Therefore, to compensate for the retardation, a compensation film has to be used to transform the light into another linear polarized light and pass through the front polarizer to resolve the viewing angle problem.

Conventionally, there are two types of compensation films: PC (polycarbonate) film and liquid crystal film. FIG. 1A is a diagram illustrating a conventional liquid crystal structure using a liquid crystal film as a compensation film. With reference to FIG. 1A, a light sequentially passes through a first polarizer 102, a main liquid crystal layer 104, a liquid crystal film 106, and a second polarizer 108. The liquid crystal film 106 is used to compensate for the retardation caused by the main liquid crystal layer 104. A disadvantage of the liquid crystal film is that it cannot achieve a biaxial compensation effect. Generally speaking, when the twist angle of the main liquid crystal layer 104 is 240 degrees to 250 degrees and the retardation of the main liquid crystal layer 104 is 780 nm to 840 nm, the twist angle of the liquid crystal film 106 has to be 190 degrees to 240 degrees and the retardation of the liquid crystal film 106 has to be 780 nm to 840 nm.

FIG. 1B is a diagram illustrating a conventional liquid crystal structure using a PC film as a compensation film. With reference to FIG. 1B, a light sequentially passes through a first polarizer 110, a first PC film 112, a main liquid crystal layer 114, a second PC film 116, and a second polarizer 118. The first PC film 112 and the second PC film 116 are used to compensate for the retardation caused by the main liquid crystal layer 114. When both the first PC film 112 and the second PC film 116 are uniaxial retardation films, they can achieve a uniaxial compensation effect. When both the first PC film 116 and the second PC film 118 are biaxial extension retardation films, they can achieve a biaxial compensation effect.

Compared to the compensation made in FIG. 1A, from the aspect of vertical viewing angle, biaxial compensation is better than liquid crystal film compensation and liquid crystal film compensation is better than uniaxial compensation. However, liquid crystal compensation film is thinner than those of the other two types of compensation films.

### SUMMARY

It is therefore an objective of the present invention to provide a liquid crystal structure, where the liquid crystal structure uses compensation films made of liquid crystal material to achieve a biaxial compensation effect.

It is another objective of the present invention to provide a liquid crystal structure, where when compared to a traditional liquid crystal structure using polycarbonate films as compensation films, the liquid structure has thinner compensation films.

It is still another objective of the present invention to provide a liquid crystal structure, where when compared to a traditional liquid crystal structure using liquid crystal films as compensation films, the compensation films used in the liquid structure have smaller twist angles and smaller retardation values.

In accordance with the foregoing and other objectives of the present invention, a liquid crystal structure for compensating for a retardation of an STN LCD is described. The liquid crystal structure includes a first polarizer, a first compensation film made of liquid crystal material, a main liquid crystal layer, a second compensation film made of liquid crystal material, and a second polarizer.

A light sequentially passes through the first polarizer, the first compensation film, the main liquid crystal layer, the second compensation film, and the second polarizer. When the light passes through the first polarizer, the light is a first linearly polarized light. When the light passes through the second polarizer, the light is a second linearly polarized light.

When the light passes through the main liquid crystal layer, a main retardation of the light is caused. When the light passes through the first compensation film and the second compensation film, a first compensation retardation and a second compensation retardation are obtained, respectively, to compensate for the main retardation, so that a biaxial compensation is achieved.

The first compensation film and the second compensation film are, for example, made of nematic liquid crystal. The first compensation retardation is 200 nm to 450 nm, and preferably 350 nm to 380 nm. The second compensation retardation is 200 nm to 450 nm, and preferably from 350 nm to 380 nm. The twist angles of the first compensation film and the second compensation film are 0 degrees to 90 degrees, respectively.

In accordance with the foregoing and other objectives of the present invention, a method for compensating for a retardation of an STN LCD is provided. The method includes the following steps. First, a main liquid crystal layer is provided. The main liquid crystal layer is an STN liquid crystal. Then, a first compensation film and a second compensation film are placed on both sides of the main liquid crystal layer. The first compensation film and the second compensation film are both made of liquid crystal material.

When a first linearly polarized light sequentially passes through the first compensation film, the main liquid crystal layer, and the second compensation film, a first compensation retardation, a main retardation, and a second compensation retardation are obtained, respectively. The first compensation retardation and the second compensation retardation are used to compensate for the main retardation, so that the first linearly polarized light is transformed into a second linearly polarized light after passing through the second compensation film and a biaxial compensation is achieved.

The invention has at least the following advantages. The liquid crystal structure uses compensation films made of liquid crystal material to achieve a biaxial compensation effect. Compared to a traditional liquid crystal structure using polycarbonate films as compensation films, the liquid crystal structure has thinner compensation films. Because the retardation of the compensation films is 350 nm to 380 nm and the twist angle of the compensation films is 0 degrees to 90 degrees, when compared to a traditional liquid crystal structure using liquid crystal films as compensation films, the liquid crystal structure has smaller twist angles and smaller retardation values for the compensation films.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a diagram illustrating a conventional liquid crystal structure using a liquid crystal film as a compensation film;

FIG. 1B is a diagram illustrating a conventional liquid crystal structure using a PC film as a compensation film;

FIG. 2 is a diagram illustrating a structure of a preferred embodiment according to the invention; and

FIG. 3 is a diagram illustrating a three-dimensional coordinate.

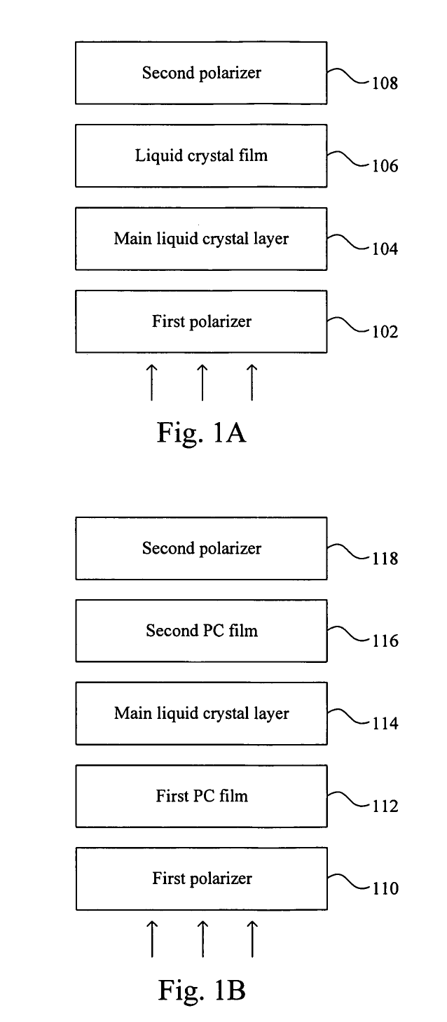

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

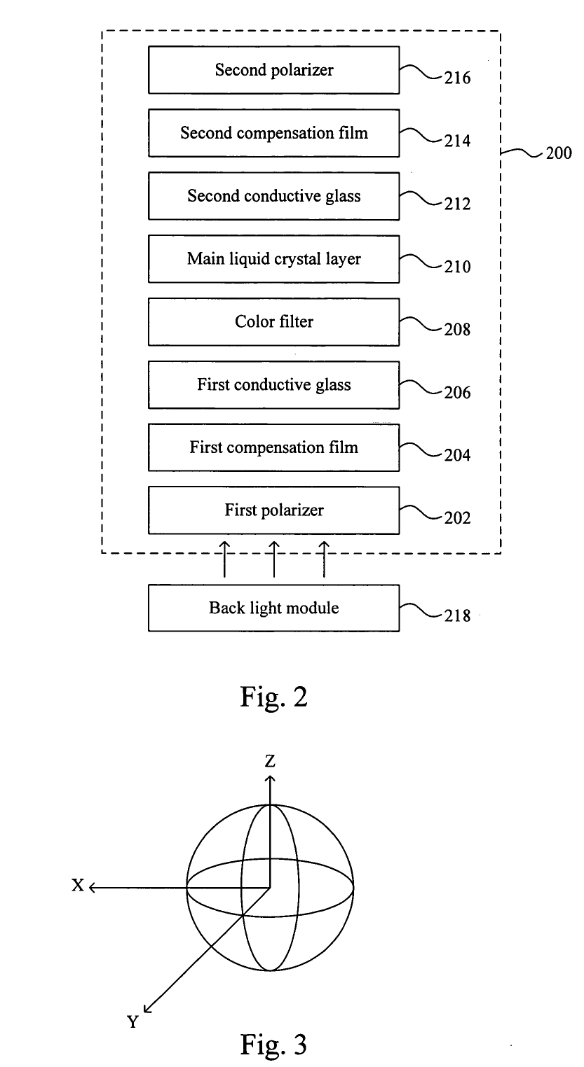

FIG. 2 is a diagram illustrating a structure of a preferred embodiment according to the invention. With reference to FIG. 2, the liquid crystal structure 200 includes a first polarizer 202, a first compensation film 204 made of liquid crystal material, a first conductive glass 206, a color filter 208, a main liquid crystal layer 210, a second conductive glass 212, a second compensation film 214 made of liquid crystal material, and a second polarizer 216. A light is generated by the back light module 218 and sequentially passes through the first polarizer 202, the first compensation film 204 made of liquid crystal material, the first conductive glass 206, the color filter 208, the main liquid crystal layer 210, the second conductive glass 212, the second compensation film 214 made of liquid crystal material, and the second polarizer 216. The first compensation film 204 and the second compensation film 214 constitute a compensation film structure. The color filter 208 can let a R (red), G (green), or B (blue) light pass for correct display.

The operation mode of the liquid crystal structure 200 is an STN (super twisted nematic) liquid crystal operation mode. Generally speaking, the liquid crystal structure 200 has a white mode and a black mode determined by the voltage difference between the second conductive glass 212 and the first conductive glass 206. When the voltage difference is 0 volts, the light passes through the second polarizer 216 and a white mode is generated. When the voltage difference is a predetermined value (such as a voltage value of 3 to 10 volts), the light is blocked by the second polarizer 216, and a black mode is generated. This invention is mainly used in the white mode for a retardation compensation of the light.

The first polarizer 202 can only allow a light with linear polarization in a specific direction to pass. The light is generated by the back light module 218. Only a linear polarized portion of the light can pass through the first polarizer 202. Therefore, after passing through the first polarizer 202, the light is linearly polarized in a specific direction and the light at this time is referred to as a first nearly polarized light. When the light passes through the main liquid crystal layer 210, a main retardation occurs because of the birefringence and twist characteristics of a liquid crystal material. The light becomes an elliptically polarized light. The light has to become a second linearly polarized light in order to pass through the second polarizer 216. Therefore, compensation films are needed to compensate for the main retardation.

In one embodiment, the first compensation film 204 and the second compensation film 214 are used to compensate for the main retardation. As shown in FIG. 2, the first compensation film 204 and the second compensation film 214 are placed on both sides of the main liquid crystal layer 210. The first compensation film 204 and the second compensation film 214 are made of nematic liquid crystal. A preferred thickness for the first compensation film 204 and the second compensation film 214 is 1.8 μm to 2.2 μm, respectively. If liquid crystal molecules in the main liquid crystal layer 210 are left-handed, right-handed liquid crystal molecules can be used in the first compensation film 204 and the second compensation film 214 to achieve the compensation effect.

When the light passes through the first compensation film 204, a first compensation retardation is obtained. When the light passes through the second compensation film 214, a second compensation retardation is obtained. The first compensation retardation and the second compensation retardation are used to compensate for the main retardation. The light then becomes a second linearly polarized light that is allowed to pass through the second polarizer 216.

For example, when the retardation of the main liquid crystal layer 210 is 780 nm to 840 nm and when the twist angle of the main liquid crystal layer 210 is 240 degrees to 250 degrees, a first compensation film 204 and a second compensation film 214 can be selected, where the retardations of the first compensation film 204 and the second compensation film 214 are 200 nm to 450 nm, respectively, and the twist angles of the first compensation film 204 and the second compensation film 214 are 0 degrees to 90 degrees, respectively. The retardation compensation effect can thus be achieved. A preferred twist angle for both the first compensation film 204 and the second compensation film 214 is 50 degrees to 70 degrees. A preferred value for both the first compensation retardation and the second compensation retardation is 350 nm to 380 nm.

A biaxial compensation effect can be achieved by the method mentioned above. FIG. 3 is a diagram illustrating a three-dimensional coordinate. With reference to FIG. 2 and FIG. 3, a light is transmitted in, for example, the Z direction. X and Y are both parallel to the tangent line of all layers of the liquid crystal structure 200. The condition, where nₓ>n_{z}>n_{y} in both the first compensation film 204 and the second compensation film 214, can be achieved in the liquid crystal structure 200. nₓ, n_{z}, and n_{y} are refraction indices for the X, Z, and Y directions, respectively. Therefore, a biaxial compensation effect can be achieved by using the first compensation film 204 and the second compensation film 214.

Conventionally, the biaxial compensation effect is achieved by using PC (polycarbonate) film as a biaxial extension retardation film. Compared to uniaxial compensation, biaxial compensation has an advantage of increasing the viewing angle in the normal direction. When N_{z}=(nₓ−n_{z})/(nₓ−n_{y}) and 0<N_{z}<1, the first compensation film 204 and the second compensation film 214 are suitable for an STN (super twisted nematic) device. The uniaxial compensation mentioned above means the compensation effect of a uniaxial retardation film under the condition where nₓ>n_{z}=n_{y}.

A method relative to the liquid crystal structure mentioned above is also disclosed in the following description. The method includes the following steps. First, a main liquid crystal layer is provided. The liquid crystal layer is an STN liquid crystal. Then, a first compensation film and a second compensation film are placed on both sides of the main liquid crystal layer. The first compensation film and the second compensation film are both made of liquid crystal material.

When a first linearly polarized light sequentially passes through the first compensation film, the main liquid crystal layer, and the second compensation film, a first compensation retardation, a main retardation, and a second compensation retardation are obtained, respectively. The first compensation retardation and the second compensation retardation are used to compensate for the main retardation, so that the first linearly polarized light is transformed into a second linearly polarized light after passing through the second compensation film and a biaxial compensation is achieved.

The materials and requirements for the first compensation film and the second compensation film are the same as those for the liquid crystal structure mentioned above.

The invention has at least the following advantages. The liquid crystal structure uses compensation films made of liquid crystal material to achieve a biaxial compensation effect. Because the retardation of the compensation films is 350 nm to 380 nm and the twist angle of the compensation films is 0 degrees to 90 degrees, when compared to a conventional liquid crystal structure using polycarbonate films as compensation films, the liquid structure has thinner compensation films, smaller twist angles and smaller retardation values for the compensation films.

Although the present invention has been described in considerable detail with reference to certain preferred embodiments thereof, other embodiments are possible. Therefore, their spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A liquid crystal structure for compensating for a retardation of an STN LCD, the liquid crystal structure comprising:
a first polarizer;
a first compensation film made of liquid crystal material;
a main liquid crystal layer;
a second compensation film made of liquid crystal material; and
a second polarizer;
wherein (i) a light sequentially passes through the first polarizer, the first compensation film, the main liquid crystal layer, the second compensation film, and the second polarizer, (ii) when the light passes through the first polarizer, the light is a first linearly polarized light, (iii) when the light passes through the second polarizer, the light is a second linearly polarized light, (iv) when the light passes through the main liquid crystal layer, a main retardation of the light is caused, and (v) when the light passes through the first compensation film and the second compensation film, a first compensation retardation and a second compensation retardation are obtained, respectively, to compensate for the main retardation, so that the first linearly polarized light is transformed into the second linearly polarized light and a biaxial compensation is achieved.

2. The liquid crystal structure of claim 1, wherein the first compensation film and the second compensation film are nematic liquid crystal.

3. The liquid crystal structure of claim 1, wherein the first compensation retardation is about 200 nm to 450 nm.

4. The liquid crystal structure of claim 3, wherein the first compensation retardation is about 350 nm to 380 nm.

5. The liquid crystal structure of claim 1, wherein the second compensation retardation is about 200 nm to 450 nm.

6. The liquid crystal structure of claim 5, wherein the second compensation retardation is about 350 nm to 380 nm.

7. The liquid crystal structure of claim 1, wherein the twist angle of the first compensation film is about 0 degrees to 90 degrees.

8. The liquid crystal structure of claim 1, wherein the twist angle of the second compensation film is about 0 degrees to 90 degrees.

9. A compensation film structure for compensating for a retardation of an STN LCD, the compensation film structure comprising:
a first compensation film made of liquid crystal material; and
a second compensation film made of liquid crystal material;
wherein (i) the first compensation film and the second compensation film are placed on both sides of a main liquid crystal layer, (ii) when a first linearly polarized light sequentially passes through the first compensation film, the main liquid crystal layer, and the second compensation film, a first compensation retardation, a main retardation, and a second compensation retardation are obtained, respectively, and (iii) the first compensation retardation and the second compensation retardation are used to compensate for the main retardation, so that the first linearly polarized light is transformed into a second linearly polarized light after passing through the second compensation film and a biaxial compensation is achieved.

10. The compensation film structure of claim 9, wherein the first compensation film and the second compensation film are nematic liquid crystal.

11. The compensation film structure of claim 9, wherein the first compensation retardation and the second compensation retardation are about 200 nm to 450 nm, respectively.

12. The compensation film structure of claim 11, wherein the first compensation retardation and the second compensation retardation are about 350 nm to 380 nm, respectively.

13. The compensation film structure of claim 9, wherein the first compensation film and the second compensation film are about 0 degrees to 90 degrees, respectively.

14. An STN liquid crystal display, comprising:
a back light module;
a first polarizer;
a first compensation film made of liquid crystal material;
a main liquid crystal layer;
a second compensation film made of liquid crystal material; and
a second polarizer;
wherein (i) a light from the back light module sequentially passes through the first polarizer, the first compensation film, the main liquid crystal layer, the second compensation film, and the second polarizer, (ii) when the light passes through the first polarizer, the light is a first linearly polarized light, (iii) when the light passes through the second polarizer, the light is a second linearly polarized light, (iv) when the light passes through the main liquid crystal layer, a main retardation of the light is caused, and (v) when the light passes through the first compensation film and the second compensation film, a first compensation retardation and a second compensation retardation are obtained, respectively, to compensate for the main retardation, so that the first linearly polarized light is transformed into the second linearly polarized light and a biaxial compensation is achieved.

15. The STN liquid crystal display of claim 14, wherein the first compensation film and the second compensation film are nematic liquid crystal.

16. The STN liquid crystal display of claim 14, wherein the first compensation retardation and the second compensation retardation are about 200 nm to 450 nm, respectively.

17. The STN liquid crystal display of claim 16, wherein the first compensation retardation and the second compensation retardation are about 350 nm to 380 nm, respectively.

18. The STN liquid crystal display of claim 14, wherein the first compensation film and the second compensation film are about 0 degrees to 90 degrees, respectively.

19. A method for compensating for a retardation of an STN LCD, the method comprising:
providing a main liquid crystal layer, wherein the main liquid crystal layer is an STN liquid crystal; and
placing a first compensation film and a second compensation film on both sides of the main liquid crystal layer, wherein the first compensation film and the second compensation film are both made of liquid crystal material;
wherein (i) when a first linearly polarized light sequentially passes through the first compensation film, the main liquid crystal layer, and the second compensation film, a first compensation retardation, a main retardation, and a second compensation retardation are obtained respectively, and (ii) the first compensation retardation and the second compensation retardation are used to compensate for the main retardation, so that the first linearly polarized light is transformed into a second linearly polarized light after passing through the second compensation film and a biaxial compensation is achieved.

20. The method of claim 19, wherein the first compensation film and the second compensation film are nematic liquid crystal.

21. The method of claim 19, wherein the first compensation retardation and the second compensation retardation are about 200 nm to 450 nm, respectively.

22. The method of claim 21, wherein the first compensation retardation and the second compensation retardation are about 350 nm to 380 nm, respectively.

23. The method of claim 19, wherein the first compensation film and the second compensation film are about 0 degrees to 90 degrees, respectively.
